(19) United States
(12) Patent Application Publication
(10) Pub. No.: US 2025/0168725 A1
(43) Pub. Date: May 22, 2025

(54) FAILURE DETECTION AND RECOVERY IN WIRELESS COMMUNICATION SYSTEM

(71) Applicant: LG ELECTRONICS INC., Seoul (KR)

(72) Inventors: Hongsuk KIM, Seoul (KR); Sunghoon JUNG, Seoul (KR); Sangwon KIM, Seoul (KR)

(73) Assignee: LG ELECTRONICS INC., Seoul (KR)

(21) Appl. No.: 18/841,539

(22) PCT Filed: Apr. 18, 2023
(86) PCT No.: PCT/KR2023/005247

§ 371 Date: Aug. 26, 2024

Related U.S. Application Data
(60) Provisional application No. 63/331,891, filed on Apr. 18, 2022.

(51) Int. Cl. H04W 36/00

(52) U.S. Cl. CPC H04W 36/0079; H04W 36/0058; H04W 36/13

(57) ABSTRACT

The present disclosure relates to failure detection and recovery in wireless communications. According to an embodiment of the present disclosure, a method performed by a user equipment (UE) configured to operate in a wireless communication system comprises: receiving a mobility command for a target cell group (CG), wherein the mobility command comprises an execution condition for a mobility to the target CG, and recovery information informing that the execution condition is used as a condition for a failure recovery; detecting a failure of a CG; evaluating the execution condition based on the recovery information after detecting the failure of the CG; and performing the mobility to the target CG based on the execution condition being fulfilled.

### CROSS-REFERENCE TO RELATED APPLICATIONS

This application is the National Stage filing under 35 U.S.C. 371 of International Application No. PCT/KR2023/005247, filed on Apr. 18, 2023, which claims the benefit of U.S. Provisional Application No. 63/331,891, filed on Apr. 18, 2022, the contents of which are all hereby incorporated by reference herein in their entireties.

### TECHNICAL FIELD

The present disclosure relates to failure detection and recovery in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a user equipment (UE) may detect a failure, such as mobility failure, radio link failure and/or beam failure. When the failure is detected, the UE may perform a recovery procedure to recover the failure.

### SUMMARY

According to an embodiment of the present disclosure, a method performed by a user equipment (UE) configured to operate in a wireless communication system comprises: receiving a mobility command for a target cell group (CG), wherein the mobility command comprises an execution condition for a mobility to the target CG, and recovery information informing that the execution condition is used as a condition for a failure recovery; detecting a failure of a CG; evaluating the execution condition based on the recovery information after detecting the failure of the CG; and performing the mobility to the target CG based on the execution condition being fulfilled.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: receiving a mobility command for a target cell group (CG), wherein the mobility command comprises an execution condition for a mobility to the target CG, and recovery information informing that the execution condition is used as a condition for a failure recovery; detecting a failure of a CG; evaluating the execution condition based on the recovery information after detecting the failure of the CG; and performing the mobility to the target CG based on the execution condition being fulfilled.

According to an embodiment of the present disclosure, a network node configured to operate in a wireless communication system comprises: at least one transceiver; at least one processor; and at least one memory operatively coupled to the at least one processor and storing instructions that, based on being executed by the at least one processor, perform operations comprising: transmitting, to a user equipment (UE), a mobility command for a target cell group (CG), wherein the mobility command comprises an execution condition for a mobility to the target CG; and receiving, from the UE, failure information to report a failure of a CG detected by the UE, based on recovery information being not included in the mobility command, wherein the recovery information informs that the execution condition is used as a condition for a failure recovery, and wherein, based on the recovery information being included in the mobility command, the UE is configured to: evaluate the execution condition after detecting the failure of the CG; and perform the mobility to the target CG based on the execution condition being fulfilled.

According to an embodiment of the present disclosure, a method performed by a network node configured to operate in a wireless communication system comprises: transmitting, to a user equipment (UE), a mobility command for a target cell group (CG), wherein the mobility command comprises an execution condition for a mobility to the target CG; and receiving, from the UE, failure information to report a failure of a CG detected by the UE, based on recovery information being not included in the mobility command, wherein the recovery information informs that the execution condition is used as a condition for a failure recovery, and wherein, based on the recovery information being included in the mobility command, the UE is configured to: evaluate the execution condition after detecting the failure of the CG; and perform the mobility to the target CG based on the execution condition being fulfilled.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: receiving a mobility command for a target cell group (CG), wherein the mobility command comprises an execution condition for a mobility to the target CG, and recovery information informing that the execution condition is used as a condition for a failure recovery; detecting a failure of a CG; evaluating the execution condition based on the recovery information after detecting the failure of the CG; and performing the mobility to the target CG based on the execution condition being fulfilled.

According to an embodiment of the present disclosure, a non-transitory computer readable medium (CRM) has stored thereon a program code implementing instructions that, based on being executed by at least one processor, perform operations comprising: receiving a mobility command for a target cell group (CG), wherein the mobility command comprises an execution condition for a mobility to the target CG, and recovery information informing that the execution condition is used as a condition for a failure recovery; detecting a failure of a CG; evaluating the execution condition based on the recovery information after detecting the failure of the CG; and performing the mobility to the target CG based on the execution condition being fulfilled.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a dual connectivity (DC) architecture to which technical features of the present disclosure can be applied.

FIG. 9 shows an example of a conditional mobility procedure to which technical features of the present disclosure can be applied.

FIG. 10 shows an example of a method performed by a UE according to an embodiment of the present disclosure.

FIG. 11 shows an example of a signal flow between a UE and a network node according to an embodiment of the present disclosure.

FIG. 12 shows an example of a method for a failure recovery according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

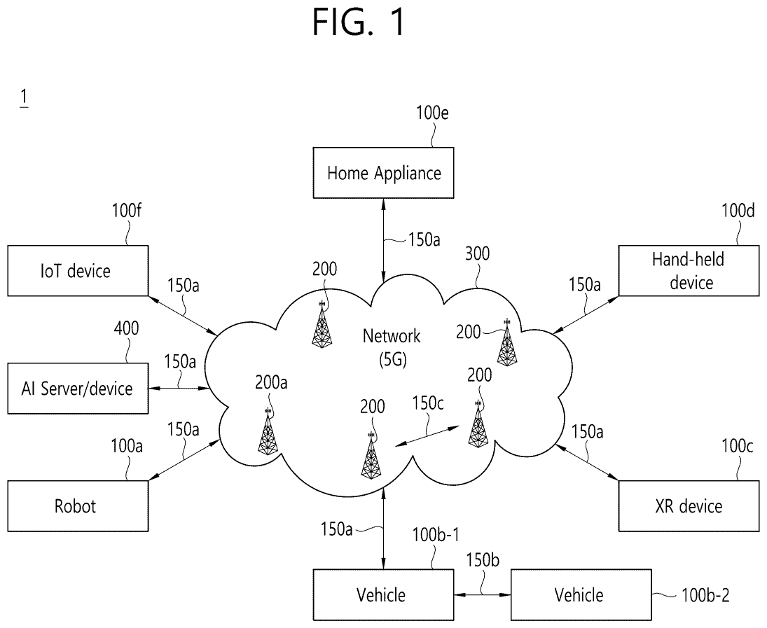

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5GNR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding frequency | | |
|---|---|---|---|
| designation | range | Subcarrier Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding frequency | | |
|---|---|---|---|
| designation | range | Subcarrier Spacing | |
| FR1 | 410 MHz-7125 MHz | 15, 30, 60 | kHz |
| FR2 | 24250 MHz-52600 MHz | 60, 120, 240 | kHz |

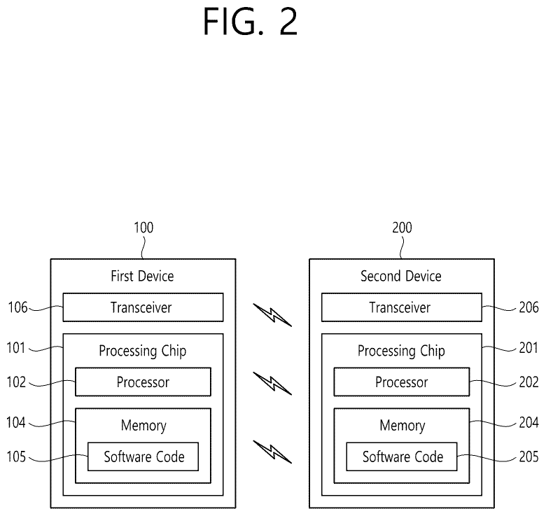

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

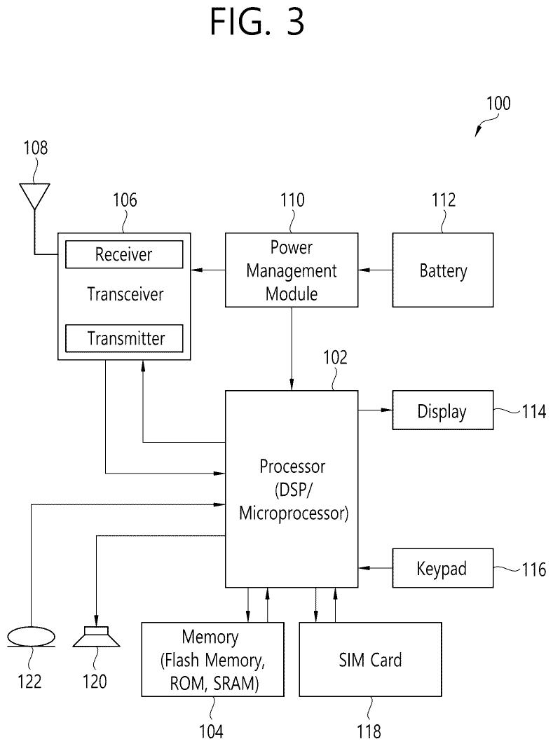

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

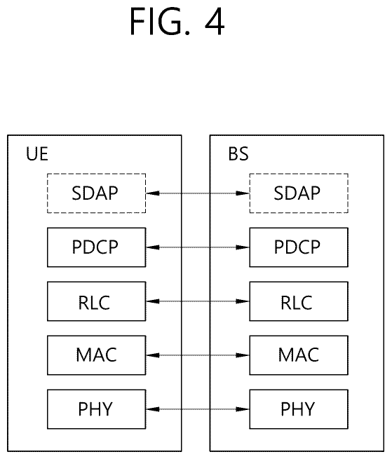

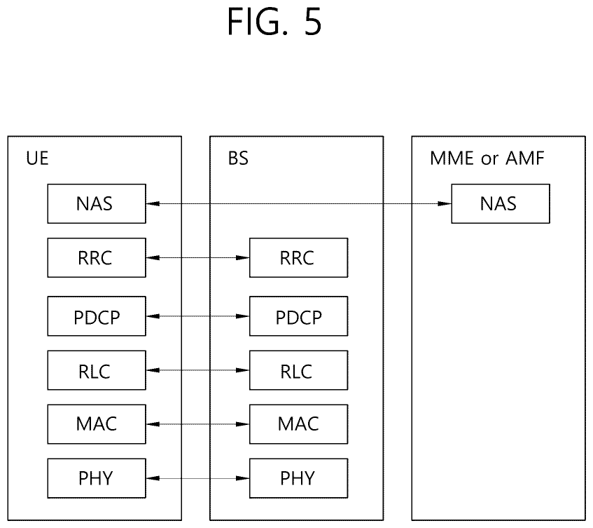

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

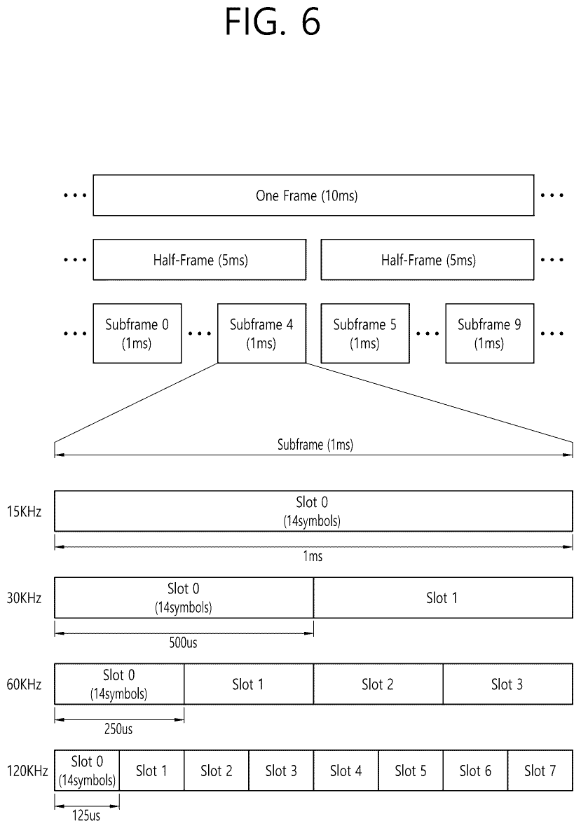

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb, the number of slots per frame N}^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

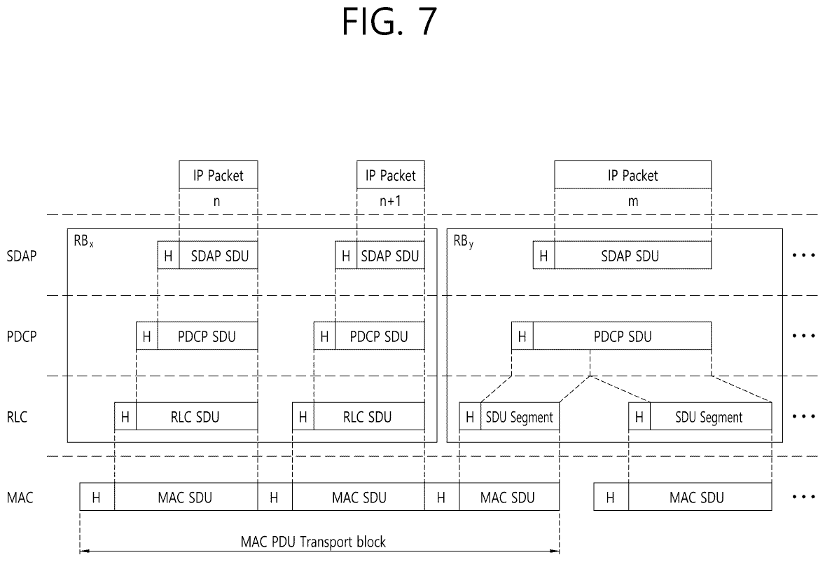

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

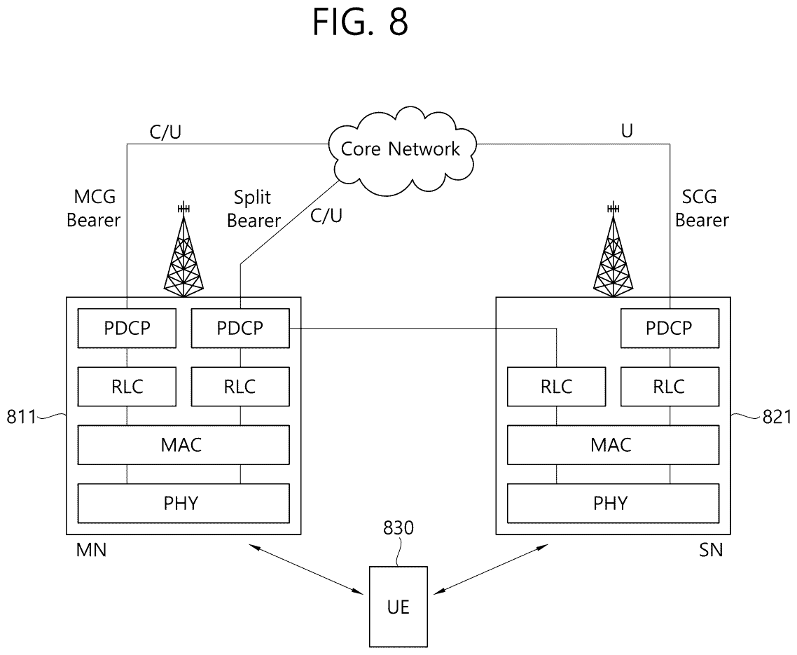

FIG. 8 shows an example of a dual connectivity (DC) architecture to which technical features of the present disclosure can be applied.

Referring to FIG. 8, MN 811, SN 821, and a UE 830 communicating with both the MN 811 and the SN 821 are illustrated. As illustrated in FIG. 8, DC refers to a scheme in which a UE (e.g., UE 830) utilizes radio resources provided by at least two RAN nodes comprising a MN (e.g., MN 811) and one or more SNs (e.g., SN 821). In other words, DC refers to a scheme in which a UE is connected to both the MN and the one or more SNs, and communicates with both the MN and the one or more SNs. Since the MN and the SN may be in different sites, a backhaul between the MN and the SN may be construed as non-ideal backhaul (e.g., relatively large delay between nodes).

MN (e.g., MN 811) refers to a main RAN node providing services to a UE in DC situation. SN (e.g., SN 821) refers to an additional RAN node providing services to the UE with the MN in the DC situation. If one RAN node provides services to a UE, the RAN node may be a MN. SN can exist if MN exists.

For example, the MN may be associated with macro cell whose coverage is relatively larger than that of a small cell. However, the MN does not have to be associated with macro cell—that is, the MN may be associated with a small cell. Throughout the disclosure, a RAN node that is associated with a macro cell may be referred to as ‘macro cell node’. MN may comprise macro cell node.

For example, the SN may be associated with small cell (e.g., micro cell, pico cell, femto cell) whose coverage is relatively smaller than that of a macro cell. However, the SN does not have to be associated with small cell—that is, the SN may be associated with a macro cell. Throughout the disclosure, a RAN node that is associated with a small cell may be referred to as ‘small cell node’. SN may comprise small cell node.

The MN may be associated with a master cell group (MCG). MCG may refer to a group of serving cells associated with the MN, and may comprise a primary cell (PCell) and optionally one or more secondary cells (SCells). User plane data and/or control plane data may be transported from a core network to the MN through a MCG bearer. MCG bearer refers to a bearer whose radio protocols are located in the MN to use MN resources. As shown in FIG. 8, the radio protocols of the MCG bearer may comprise PDCP, RLC, MAC and/or PHY.

The SN may be associated with a secondary cell group (SCG). SCG may refer to a group of serving cells associated with the SN, and may comprise a primary secondary cell (PSCell) and optionally one or more SCells. User plane data may be transported from a core network to the SN through a SCG bearer. SCG bearer refers to a bearer whose radio protocols are located in the SN to use SN resources. As shown in FIG. 8, the radio protocols of the SCG bearer may comprise PDCP, RLC, MAC and PHY.

User plane data and/or control plane data may be transported from a core network to the MN and split up/duplicated in the MN, and at least part of the split/duplicated data may be forwarded to the SN through a split bearer. Split bearer refers to a bearer whose radio protocols are located in both the MN and the SN to use both MN resources and SN resources. As shown in FIG. 8, the radio protocols of the split bearer located in the MN may comprise PDCP, RLC, MAC and PHY. The radio protocols of the split bearer located in the SN may comprise RLC, MAC and PHY.

According to various embodiments, PDCP anchor/PDCP anchor point/PDCP anchor node refers to a RAN node comprising a PDCP entity which splits up and/or duplicates data and forwards at least part of the split/duplicated data over X2/Xn interface to another RAN node. In the example of FIG. 8, PDCP anchor node may be MN.

According to various embodiments, the MN for the UE may be changed. This may be referred to as handover, or a MN handover.

According to various embodiments, a SN may newly start providing radio resources to the UE, establishing a connection with the UE, and/or communicating with the UE (i.e., SN for the UE may be newly added). This may be referred to as a SN addition.

According to various embodiments, a SN for the UE may be changed while the MN for the UE is maintained. This may be referred to as a SN change.

According to various embodiments, DC may comprise E-UTRAN NR-DC (EN-DC), and/or multi-radio access technology (RAT)-DC (MR-DC). EN-DC refers to a DC situation in which a UE utilizes radio resources provided by E-UTRAN node and NR RAN node. MR-DC refers to a DC situation in which a UE utilizes radio resources provided by RAN nodes with different RATs.

Hereinafter, failure related actions are described. In the present disclosure, “failure” may comprise radio link failure such as MCG failure or SCG failure, beam failure and/or reconfiguration with sync failure (i.e., mobility failure/T340 expiry).

### 1. Radio Link Failure Related Actions

### (1) Detection of Physical Layer Problems

The UE shall:
1> if any DAPS bearer is configured, upon receiving N310 consecutive “out-of-sync” indications for the source SpCell from lower layers and T304 is running:
2> start timer T310 for the source SpCell.
1> upon receiving N310 consecutive “out-of-sync” indications for the SpCell from lower layers while neither T300, T301, T304, T311, T316 nor T319 are running:
2> start timer T310 for the corresponding SpCell.

### (2) Recovery of Physical Layer Problems

Upon receiving N311 consecutive “in-sync” indications for the SpCell from lower layers while T310 is running, the UE shall:
1> stop timer T310 for the corresponding SpCell.
1> stop timer T312 for the corresponding SpCell, if running.

In this case, the UE maintains the RRC connection without explicit signalling, i.e. the UE maintains the entire radio resource configuration.

Periods in time where neither “in-sync” nor “out-of-sync” is reported by L1 do not affect the evaluation of the number of consecutive “in-sync” or “out-of-sync” indications.

### (3) Detection of Radio Link Failure

The UE shall:
1> if any DAPS bearer is configured and T304 is running:
2> upon T310 expiry in source SpCell; or
2> upon random access problem indication from source MCG MAC; or
2> upon indication from source MCG RLC that the maximum number of retransmissions has been reached; or
2> upon consistent uplink LBT failure indication from source MCG MAC:
3> consider radio link failure to be detected for the source MCG i.e. source RLF;
3> suspend the transmission and reception of all DRBs and multicast MRBs in the source MCG;
3> reset MAC for the source MCG;
3> release the source connection.
1> else:
2> during a DAPS handover: the following only applies for the target PCell;
2> upon T310 expiry in PCell; or
2> upon T312 expiry in PCell; or
2> upon random access problem indication from MCG MAC while neither T300, T301, T304, T311 nor T319 are running and SDT procedure is not ongoing; or
2> upon indication from MCG RLC that the maximum number of retransmissions has been reached while SDT procedure is not ongoing; or
2> if connected as an IAB-node, upon BH RLF indication received on BAP entity from the MCG; or
2> upon consistent uplink LBT failure indication from MCG MAC while T304 is not running:
3> if the indication is from MCG RLC and CA duplication is configured and activated for MCG, and for the corresponding logical channel allowedServingCells only includes SCell(s):
4> initiate the failure information procedure to report RLC failure.
3> else:
4> consider radio link failure to be detected for the MCG, i.e. MCG RLF;
4> discard any segments of segmented RRC messages;
4> if AS security has not been activated:
5> perform the actions upon going to RRC_IDLE with release cause ‘other’;—
4> else if AS security has been activated but SRB2 and at least one DRB or multicast MRB or, for IAB, SRB2, have not been setup:
5> store the radio link failure information in the VarRLF-Report;
5> perform the actions upon going to RRC_IDLE, with release cause ‘RRC connection failure’;
4> else:
5> store the radio link failure information in the VarRLF-Report;
5> if T316 is configured; and
5> if SCG transmission is not suspended; and
5> if the SCG is not deactivated; and
5> if neither PSCell change nor PSCell addition is ongoing (i.e. timer T304 for the NR PSCell is not running in case of NR-DC or timer T307 of the E-UTRA PSCell is not running, in NE-DC):
6> initiate the MCG failure information procedure to report MCG radio link failure.
5> else:
6> initiate the connection re-establishment procedure.

The UE shall:
1> upon T310 expiry in PSCell; or
1> upon T312 expiry in PSCell; or
1> upon random access problem indication from SCG MAC; or
1> upon indication from SCG RLC that the maximum number of retransmissions has been reached; or
1> if connected as an IAB-node, upon BH RLF indication received on BAP entity from the SCG; or
1> upon consistent uplink LBT failure indication from SCG MAC:
2> if the indication is from SCG RLC and CA duplication is configured and activated for SCG, and for the corresponding logical channel allowedServingCells only includes SCell(s):
3> initiate the failure information procedure to report RLC failure.
2> else:
3> consider radio link failure to be detected for the SCG, i.e. SCG RLF;
3> if the SCG is deactivated:
4> stop radio link monitoring on the SCG;
4> indicate to lower layers to stop beam failure detection on the PSCell;
3> if MCG transmission is not suspended:
4> initiate the SCG failure information procedure to report SCG radio link failure.
3> else:
4> if the UE is in NR-DC:
5> initiate the connection re-establishment procedure;
4> else (the UE is in (NG)EN-DC):
5> initiate the connection re-establishment procedure.
   2. Reconfiguration with Sync Failure (i.e., T304 Expiry and/or Mobility Failure)

The UE shall:
1> if T304 of the MCG expires;
2> release dedicated preambles provided in rach-ConfigDedicated if configured;
2> release dedicated msgA PUSCH resources provided in rach-ConfigDedicated if configured;
2> if any DAPS bearer is configured, and radio link failure is not detected in the source PCel:
3> reset MAC for the target PCell and release the MAC configuration for the target PCell;
3> for each DAPS bearer:
4> release the RLC entity or entities, and the associated logical channel for the target PCell;
4> reconfigure the PDCP entity to release DAPS;
3> for each SRB:
4> if the masterKeyUpdate was not received:
5> configure the PDCP entity for the source PCell with state variables continuation;
4> release the PDCP entity for the target PCell;
4> release the RLC entity, and the associated logical channel for the target PCell;
4> trigger the PDCP entity for the source PCell to perform SDU discard;
4> re-establish the RLC entity for the source PCell;
3> release the physical channel configuration for the target PCell;
3> discard the keys used in target PCell (the K_{gNB} key, the K_{RRCene} key, the K_{RRCint} key, the K_{UPint} key and the K_{UPene} key), if any;
3> resume suspended SRBs in the source PCell;
3> for each non-DAPS bearer:
4> revert back to the UE configuration used for the DRB or multicast MRB in the source PCell, includes PDCP, RLC states variables, the security configuration and the data stored in transmission and reception buffers in PDCP and RLC entities;
3> revert back to the UE measurement configuration used in the source PCell;
3> store the handover failure information in VarRLF-Report;
3> initiate the failure information procedure to report DAPS handover failure.
2> else:
3> revert back to the UE configuration used in the source PCell;
3> if the associated T304 was not initiated upon cell selection performed while timer T311 was running:
4> store the handover failure information in VarRLF-Report;
3> initiate the connection re-establishment procedure.
1> else if T304 of a secondary cell group expires:
2> if MCG transmission is not suspended:
3> release dedicated preambles provided in rach-ConfigDedicated, if configured;
3> release dedicated msgA PUSCH resources provided in rach-ConfigDedicated, if configured;
3> initiate the SCG failure information procedure to report SCG reconfiguration with sync failure, upon which the RRC reconfiguration procedure ends;
2> else:
3> if the UE is in NR-DC:
4> initiate the connection re-establishment procedure;
3> else (the UE is in (NG) EN-DC):
4> initiate the connection re-establishment procedure;
1> else if T304 expires when RRCReconfiguration is received via other RAT (HO to NR failure):
2> reset MAC;
2> perform the actions defined for this failure case as defined in the specifications applicable for the other RAT.

### 3. Beam Failure Detection and Recovery Procedure

The MAC entity may be configured by RRC per Serving Cell or per BFD-RS set with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration. The Serving Cell is configured with two BFD-RS sets if and only if failureDetectionSet1 and failureDetectionSet2 are configured for the active DL BWP of the Serving Cell. When the SCG is deactivated, the UE performs beam failure detection on the PSCell if bfd-and-RLM is set to true.

For the beam failure detection procedure, the UE variable “BFI_COUNTER” is used. The BFI_COUNTER is a counter for beam failure instance indication which is initially set to 0, and defined per Serving Cell or per BFD-RS set of Serving Cell configured with two BFD-RS sets.

The MAC entity shall for each Serving Cell configured for beam failure detection:
1> if the Serving Cell is configured with two BFD-RS sets:
2> if beam failure instance indication for a BFD-RS set has been received from lower layers:
3> start or restart the beamFailureDetectionTimer of the BFD-RS set;
3> increment BFI_COUNTER of the BFD-RS set by 1;
3> if BFI_COUNTER of the BFD-RS set >=beamFailureInstanceMaxCount:
4> trigger a BFR for this BFD-RS set of the Serving Cell;
2> if BFR is triggered for both BFD-RS sets of the SpCell and the Beam Failure Recovery procedure is not successfully completed for any of the BFD-RS sets:
3> initiate a Random Access procedure on the SpCell;
2> if the Serving Cell is SpCell and the Random Access procedure initiated for beam failure recovery of both BFD-RS sets of SpCell is successfully completed:
3> set BFI_COUNTER of each BFD-RS set of SpCell to 0.
3> consider the Beam Failure Recovery procedure successfully completed.
2> if the beamFailureDetectionTimer of this BFD-RS set expires; or
2> if beamFailureDetectionTimer, beamFailureInstanceMaxCount, or any of the reference signals used for beam failure detection is reconfigured by upper layers or by the BFD-RS Indication MAC CE associated with a BFD-RS set of the Serving Cell; or
2> if the reference signal(s) associated with a BFD-RS set of the Serving Cell used for beam failure detection is changed:
3> set BFI_COUNTER of the BFD-RS set to 0.
2> if a PDCCH addressed to C-RNTI indicating uplink grant for a new transmission is received for the HARQ process used for the transmission of the Enhanced BFR MAC CE or Truncated Enhanced BFR MAC CE which contains beam failure recovery information of this BFD-RS set of the Serving Cell:
3> set BFI_COUNTER of the BFD-RS set to 0;
3> consider the Beam Failure Recovery procedure successfully completed for this BFD-RS set and cancel all the triggered BFRs of this BFD-RS set of the Serving Cell.
2> if the Serving Cell is SCell and the SCell is deactivated:
3> set BFI_COUNTER of each BFD-RS set of SCell to 0;
3> consider the Beam Failure Recovery procedure successfully completed and cancel all the triggered BFRs of all BFD-RS sets of the Serving Cell.
1> else:
2> if beam failure instance indication has been received from lower layers:
3> start or restart the beamFailureDetectionTimer;
3> increment BFI_COUNTER by 1;
3> if BFI_COUNTER>=beamFailureInstanceMaxCount:
4> if the Serving Cell is SCell:
5> trigger a BFR for this Serving Cell;
4> else if the Serving Cell is PSCell and, the SCG is deactivated:
5> if beam failure of the PSCell has not been indicated to upper layers since the SCG was deactivated or since the deactivated SCG was last reconfigured with BFD-RS:
6> indicate beam failure of the PSCell to upper layers.

After beam failure is indicated to upper layers, the UE may stop the beamFailureDetectionTimer and lower layer beam failure indication while BFI_COUNTER >=beamFailureInstanceMaxCount for the deactivated SCG.
4> else:
5> initiate a Random Access procedure on the SpCell.
2> if the beamFailureDetectionTimer expires; or
2> if beamFailureDetectionTimer, beamFailureInstanceMaxCount, or any of the reference signals used for beam failure detection is reconfigured by upper layers associated with this Serving Cell; or
2> if the reference signal(s) associated with this Serving Cell used for beam failure detection is changed:
3> set BFI_COUNTER to 0.
2> if the Serving Cell is SpCell and the Random Access procedure initiated for SpCell beam failure recovery is successfully completed:
3> set BFI_COUNTER to 0;
3> stop the beamFailureRecoveryTimer, if configured;
3> consider the Beam Failure Recovery procedure successfully completed.
2> else if the Serving Cell is SCell, and a PDCCH addressed to C-RNTI indicating uplink grant for a new transmission is received for the HARQ process used for the transmission of the MAC CE for BFR which contains beam failure recovery information of this Serving Cell; or
2> if the SCell is deactivated:
3> set BFI_COUNTER to 0;
3> consider the Beam Failure Recovery procedure successfully completed and cancel all the triggered BFRs for this Serving Cell.

The MAC entity shall:
1> if the Beam Failure Recovery procedure determines that at least one BFR has been triggered and not cancelled for an SCell for which evaluation of the candidate beams according to the requirements has been completed and if none of the Serving Cell(s) of this MAC entity are configured with two BFD-RS sets:
2> if UL-SCH resources are available for a new transmission and if the UL-SCH resources can accommodate the BFR MAC CE plus its subheader as a result of LCP:
3> instruct the Multiplexing and Assembly procedure to generate the BFR MAC CE.
2> else if UL-SCH resources are available for a new transmission and if the UL-SCH resources can accommodate the Truncated BFR MAC CE plus its subheader as a result of LCP:
3> instruct the Multiplexing and Assembly procedure to generate the Truncated BFR MAC CE.
2> else:
3> trigger the SR for SCell beam failure recovery for each SCell for which BFR has been triggered, not cancelled, and for which evaluation of the candidate beams according to the requirements has been completed.
1> if the Beam Failure Recovery procedure determines that at least one BFR for any BFD-RS set has been triggered and not cancelled for an SCell for which evaluation of the candidate beams according to the requirements has been completed; or
1> if the Beam Failure Recovery procedure determines that at least one BFR for only one BFD-RS set has been triggered and not cancelled for an SpCell for which evaluation of the candidate beams according to the requirements; or
1> if the Beam Failure Recovery procedure determines that at least one BFR has been triggered and not cancelled for an SCell for which evaluation of the candidate beams according to the requirements has been completed and if at least one Serving Cell of this MAC entity is configured with two BFD-RS sets:
2> if UL-SCH resources are available for a new transmission and if the UL-SCH resources can accommodate the Enhanced BFR MAC CE plus its subheader as a result of LCP:
3> instruct the Multiplexing and Assembly procedure to generate the Enhanced BFR MAC CE.
2> else if UL-SCH resources are available for a new transmission and if the UL-SCH resources can accommodate the Truncated Enhanced BFR MAC CE plus its subheader as a result of LCP:
3> instruct the Multiplexing and Assembly procedure to generate the Truncated Enhanced BFR MAC CE.
2> else:
3> trigger the SR for beam failure recovery of each BFD-RS set for which BFR has been triggered, not cancelled, and for which evaluation of the candidate beams according to the requirements has been completed;
3> trigger the SR for SCell beam failure recovery for each SCell for which BFR has been triggered, not cancelled, and for which evaluation of the candidate beams according to the requirements has been completed.

All BFRs triggered for an SCell shall be cancelled when a MAC PDU is transmitted and this PDU includes a MAC CE for BFR which contains beam failure information of that SCell. All BFRs triggered for a BFD-RS set of a Serving Cell shall be cancelled when a MAC PDU is transmitted and this PDU includes an Enhanced BFR MAC CE or Truncated Enhanced BFR MAC CE which contains beam failure recovery information of that BFD-RS set of the Serving Cell.

Hereinafter, mobility is described.

In the disclosure, ‘Mobility’ refers to a procedure for i) changing a PCell of a UE (i.e., handover or PCell change), ii) changing a PSCell of a UE (i.e., SN change or PSCell change), and/or iii) adding a PSCell for a UE (i.e., SN addition or PSCell addition). Therefore, the mobility may comprise at least one of a handover, an SN change or an SN addition. In other words, the mobility may comprise at least one of PCell change, PSCell change or PSCell addition. Throughout the disclosure, performing a mobility to a target cell may refer to applying a mobility command of the target cell or applying a target cell configuration for the target cell in the mobility command of the target cell. The target cell configuration for the target cell may comprise RRC reconfiguration (i.e., RRCReconfiguration message) including RRC reconfiguration parameters associated with the mobility to the target cell. Further, RRC reconfiguration and RRC connection reconfiguration may be used interchangeably.

In the disclosure, the target cell configuration may also be referred to as candidate cell configuration. The candidate cell configuration may comprise reconfigurationWithSync, which comprise parameters for the synchronous reconfiguration to the target SpCell. For example, the reconfigurationWithSync may comprise at least one of a new UE-identity (i.e., a kind of RNTI value), timer T304, spCellConfigCommon, rach-ConfigDedicated or smtc. The spCellConfigCommon may comprise ServingCellConfigCommon which is used to configure cell specific parameters of SpCell. The rach-ConfigDedicated may indicate a random access configuration to be used for a reconfiguration with sync (e.g., mobility). The smtc may indicate a synchronization signal/physical broadcast channel (SS/PBCH) block periodicity/offset/duration configuration of target cell for PSCell change, PCell change and/or PSCell addition. The SS/PBCH block may be simply referred to as synchronization signal block (SSB).

‘SN mobility’ refers to a procedure for i) changing a PSCell of a UE (i.e., SN change or PSCell change), and/or ii) adding a PSCell for a UE (i.e., SN addition or PSCell addition). Therefore, the SN mobility may comprise at least one of an SN change or an SN addition. In other words, the SN mobility may comprise at least one of PSCell change or PSCell addition. Throughout the disclosure, performing an SN mobility to a target cell may refer to applying an SN mobility command of the target cell or applying a target cell configuration for the target cell in the SN mobility command of the target cell. The target cell configuration for the target cell may comprise RRC reconfiguration (i.e., RRCReconfiguration message) including RRC reconfiguration parameters associated with the SN mobility to the target cell. The SN mobility may be a kind of a mobility. The SN mobility command may comprise a SN change command for performing SN change, or SN addition command for performing SN addition.

‘Conditional mobility’ refers to a mobility that is performed to a target cell which fulfils an execution condition among a plurality of candidate target cells. Throughout the disclosure, performing a conditional mobility to a target cell may refer to applying a conditional mobility command of a target cell which fulfils a mobility condition for the target cell among a plurality of candidate target cells or applying a target cell configuration for the target cell in the conditional mobility command of the target cell which fulfils a mobility condition for the target cell among the plurality of candidate target cells. The target cell configuration for the target cell may comprise RRC reconfiguration (i.e., RRCReconfiguration message) including RRC reconfiguration parameters associated with the conditional mobility to the target cell. Conditional mobility may comprise a conditional handover (i.e., conditional PCell change/CHO), a conditional SN change (i.e., conditional PSCell change (CPC)), and/or conditional SN addition (i.e., conditional PSCell addition (CPA)). The conditional PSCell addition/change (CPAC) may comprise the CPC and/or the CPA.

‘Mobility condition for a target cell’ refers to an execution condition for a mobility to the target cell. That is, the mobility condition for a target cell refers to a condition that should be fulfilled for executing a mobility to the target cell. Mobility condition may comprise at least one of event A3 condition (i.e., mobility condition for event A3/condEventA3), event A4 condition (i.e., mobility condition for event A4/condEventA4), or event A5 condition (i.e., mobility condition for event A5/condEventA5). The event A3 condition may comprise at least one of an offset value, or a time-to-trigger (TTT). The event A4 condition may comprise at least one of a target cell threshold, or a TTT. The event A5 condition may comprise at least one of a serving cell threshold, a target cell threshold, or a TTT. The mobility condition for an event may be fulfilled if/when an entering condition (or, also referred to as entry condition) for the event is fulfilled for at least the TTT. For example, the entering condition for event A3 may be fulfilled if a signal quality for a target cell is better than that for a serving cell more than or equal to the offset value. An entering condition for event A4 may be fulfilled if a signal quality for a target cell is better than the target cell threshold. An entering condition for event A5 may be fulfilled if a signal quality for a target cell is better than the target cell threshold and a signal quality for a serving cell is lower than the serving cell threshold. The mobility condition may also be referred to as a triggering condition/conditional execution condition/conditional mobility execution condition (e.g., CHO execution condition).

‘SN mobility condition for a target cell’ refers to an execution condition for an SN mobility (i.e., SN addition or SN change) to the target cell. That is, the SN mobility condition for a target cell refers to a condition that should be fulfilled for executing an SN mobility to the target cell. SN mobility condition for a target cell may be classified as:
i) SN addition condition for a target cell, which refers to an execution condition for an SN addition of the target cell; or
ii) SN change condition for a target cell, which refers to an execution condition for an SN change to the target cell.

The mobility condition may inform at least one measurement ID. For example, the mobility condition may inform at most 2 measurement IDs. If a mobility condition of a target cell informs a measurement ID which is related to a report configuration, the mobility condition of the target cell may be a condition (e.g., event A3/A4/A5 condition) specified/indicated by a conditional reconfiguration triggering configuration (i.e., CondTriggerConfig) in the report configuration. The conditional reconfiguration triggering configuration may further specify/indicate a type of reference signal to measure for evaluating the mobility condition.

For CHO, intra-SN CPC and SN initiated inter-SN CPC, the mobility command may comprise at least one of event A3 condition or event A5 condition. For CPA and MN-initiated inter-SN CPC, the mobility condition may comprise event A4 condition.

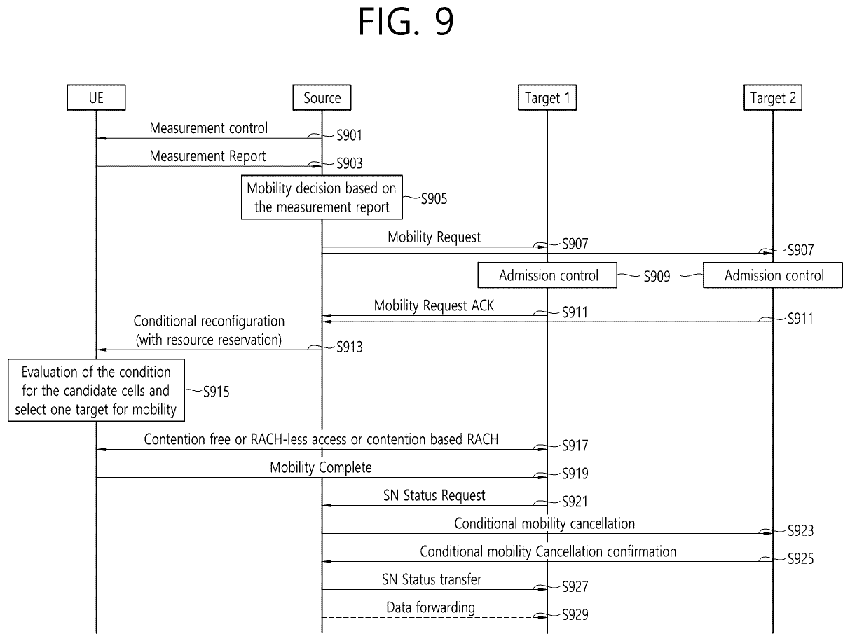

FIG. 9 shows an example of a conditional mobility procedure to which technical features of the present disclosure can be applied. The steps illustrated in FIG. 9 can also be applied to a conditional handover procedure, conditional SN addition procedure and/or conditional SN change procedure.

Referring to FIG. 9, in step S901, the source cell may transmit measurement control message to the UE. The measurement control message may comprise a measurement configuration including a list of measurement configurations, and each measurement configuration in the list includes a measurement identity (ID), the corresponding measurement object and the corresponding report configuration.

In step S903, the UE may transmit a measurement report message to the source cell. The measurement report message may comprise a result of measurement on neighbor cell(s) around the UE which can be detected by the UE. The UE may generate the measurement report message according to a measurement configuration and/or measurement control information in the measurement control message received in step S901.

In step S905, the source cell may make a mobility decision based on the measurement report. For example, the source cell may make a mobility decision and determine candidate target cells (e.g., target cell 1 and target cell 2) for mobility among neighbor cells around the UE based on a result of measurement (e.g., signal quality, reference signal received power (RSRP), reference signal received quality (RSRP)) on the neighbor cells.

In step S907, the source cell may transmit mobility request messages to the target cell 1 and the target cell 2 which are determined in step S905. That is, the source cell may perform mobility preparation with the target cell 1 and the target cell 2. The mobility request message may comprise necessary information to prepare the mobility at the target side (e.g., target cell 1 and target cell 2).

In step S909, each of the target cell 1 and the target cell 2 may perform an admission control based on information included in the mobility request message. The target cell may configure and reserve the required resources (e.g., C-RNTI and/or RACH preamble). The AS-configuration to be used in the target cell can either be specified independently (i.e. an “establishment”) or as a delta compared to the AS-configuration used in the source cell (i.e. a “reconfiguration”).

In step S911, the target cell and the target cell 2 may transmit a mobility request acknowledge (ACK) message to the source cell. The mobility request ACK message may comprise target cell configuration (i.e., RRCReconfiguration message including ReconfigurationWithSync) including information on resources reserved and prepared for a mobility. For example, the mobility request ACK message may comprise a transparent container to be sent to the UE as an RRC message (i.e., RRCReconfiguration message/target cell configuration) to perform the mobility. The container/target cell configuration/RRCReconfiguration message may include a new C-RNTI, target gNB security algorithm identifiers for the selected security algorithms, access configuration such as dedicated RACH resources including dedicated preamble, and/or possibly some other parameters i.e., access parameters, SIBs. If RACH-less mobility is configured, the container may include timing adjustment indication and optionally a pre-allocated uplink grant. The mobility request ACK message may also include RNL/TNL information for forwarding tunnels, if necessary. As soon as the source cell receives the mobility request ACK message, or as soon as the transmission of the conditional mobility command is initiated in the downlink, data forwarding may be initiated.

In step S913, the source cell may transmit a RRCReconfiguration message including a conditional reconfiguration to the UE. The conditional reconfiguration may be also referred to as (or, may comprise) conditional handover (CHO) configuration and/or a conditional mobility command (e.g., CHO command). The conditional reconfiguration may comprise a list of conditional reconfigurations/conditional mobility commands, including a conditional reconfiguration/conditional mobility command for each of the candidate target cells (e.g., target cell 1, target cell 2). For example, the conditional reconfiguration may comprise a conditional reconfiguration/conditional mobility command for the target cell 1, and a conditional reconfiguration/conditional mobility command for the target cell 2. The conditional reconfiguration for the target cell 1 may comprise an index/identifier identifying the corresponding conditional reconfiguration, a mobility condition for the target cell 1, and/or a target cell configuration for the target cell 1. The target cell configuration for the target cell 1 (i.e., RRCReconfiguration message including ReconfigurationWithSync for the target cell 1 received from the target cell 1 in step S911) may comprise RRC reconfiguration parameters associated with a mobility to the target cell 1, including information on resources reserved and prepared for the mobility to the target cell 1. Similarly, the conditional reconfiguration for the target cell 2 may comprise an index/identifier identifying the corresponding conditional reconfiguration, a mobility condition for the target cell 2, and a target cell configuration for the target cell 2. The target cell configuration for the target cell 2 (i.e., RRCReconfiguration message including ReconfigurationWithSync for the target cell 2 received from the target cell 2 in step S911) may comprise RRC reconfiguration parameters associated with a mobility to the target cell 2, including information on resources reserved and prepared for the mobility to the target cell 2.

For example, the conditional reconfiguration (i.e., ConditionalReconfiguration) may comprise a list of conditional mobility commands/conditional reconfigurations (i.e., CondReconfigToAddModList), as shown in table 5:

TABLE 5
ConditionalReconfiguration-r16 ::= SEQUENCE { attemptCondReconfig-r16
ENUMERATED {true} OPTIONAL, -- Cond CHO
condReconfigToRemoveList-r16 CondReconfigToRemoveList-r16
OPTIONAL, -- Need N condReconfigToAddModList-r16
CondReconfigToAddModList-r16 OPTIONAL, -- Need
N ...}CondReconfigToRemoveList-r16 ::= SEQUENCE (SIZE (1..
maxNrofCondCells-r16)) OF CondReconfigId-r16

In table 5, if attemptCondReconfig is present, the UE shall perform conditional reconfiguration if selected cell is a target candidate cell and it is the first cell selection after failure. The CondReconfigToAddModList may be a list of the configuration (e.g., list of mobility commands) of candidate SpCells to be added or modified for CHO, CPA or CPC. The condReconfigToRemoveList may be a list of the configuration (e.g., list of mobility commands) of candidate SpCells to be removed. Each conditional reconfiguration/mobility command (i.e., CondReconfigToAddMod) in the CondReconfigToAddModList may comprise an index/identifier identifying the corresponding conditional reconfiguration (i.e., condReconfigId), a mobility condition (i.e., condExecutionCond), and a target cell configuration (i.e., condRRCReconfig) as shown in table 6:

TABLE 6
CondReconfigToAddModList-r16 ::= SEQUENCE (SIZE (1.. maxNrofCondCells-r16)) OF
CondReconfigToAddMod-r16CondReconfigToAddMod-r16 ::= SEQUENCE
{ condReconfigId-r16 CondReconfigId-r16, condExecutionCond-
r16 SEQUENCE (SIZE (1..2)) OF MeasId
OPTIONAL, -- Need M condRRCReconfig-r16 OCTET STRING
(CONTAINING RRCReconfiguration) OPTIONAL, -- Cond
condReconfigAdd ..., [[ condExecutionCondSCG-r17 OCTET
STRING (CONTAINING CondReconfigExecCondSCG-r17) OPTIONAL -- Need
M ]]}CondReconfigExecCondSCG-r17 ::= SEQUENCE (SIZE (1..2)) OF MeasId

In table 6:—The condExecutionCond may be the execution condition that needs to be fulfilled in order to trigger the execution of a conditional reconfiguration for CHO, CPA, intra-SN CPC without MN involvement or MN initiated inter-SN CPC. When configuring 2 triggering events (Meas Ids) for a candidate cell, the network ensures that both refer to the same measObject. For CPA and for MN-initiated inter-SN CPC, the network only indicates MeasId(s) associated with condEventA4. For intra-SN CPC, the network only indicates MeasId(s) associated with condEventA3 or condEventA5.

The condExecutionCondSCG contains execution condition that needs to be fulfilled in order to trigger the execution of a conditional reconfiguration for SN initiated inter-SN CPC. The Meas Ids refer to the measConfig associated with the SCG. When configuring 2 triggering events (Meas Ids) for a candidate cell, network ensures that both refer to the same measObject. For each condReconfigId, the network always configures either condExecutionCond or condExecutionCondSCG (not both). The network only indicates MeasId(s) associated with condEventA3 or condEventA5.

The condRRCReconfig may be the RRCReconfiguration message to be applied when the condition(s) are fulfilled.

In step S915, the UE may perform an evaluation of the mobility condition for the candidate target cells (e.g., target cell 1, target cell 2) and select a target cell for a mobility among the candidate target cells. For example, the UE may perform measurements on the candidate target cells, and determine whether a candidate target cell fulfils a mobility condition for the candidate target cell among the candidate target cells based on a result of the measurements on the candidate target cells. Or, the UE may determine whether the target cell/measurement result for the target cell fulfils the mobility condition of the target cell. If the UE identifies that the target cell 1 fulfils a mobility condition for the target cell 1, the UE may select the target cell 1 as a target cell for the mobility. Then, the UE may apply the target cell configuration for the selected target cell (i.e., execute conditional reconfiguration for the selected target cell/initiate conditional mobility to the selected target cell) and/or initiate a random access procedure to the selected target cell. Upon applying the target cell configuration for the selected target cell and/or initiating the random access procedure to the selected target cell, the UE may start T304 timer.

In step S917, the UE may perform conditional mobility to the selected target cell while the T304 timer is running. For example, the UE may transmit a random access preamble to the target cell 1, and receive a random access response comprising an uplink grant from the target cell 1. If RACH-less mobility is configured, the uplink grant may be provided in step S913.

In step S919, the UE may transmit a mobility complete message (i.e., RRCReconfigurationComplete message) to the target cell 1. When the UE has successfully accessed the target cell 1 (or, received uplink grant when RACH-less mobility is configured), the UE may transmit, based on the received uplink grant, a mobility complete message comprising a C-RNTI to confirm the mobility, along with uplink buffer status report, whenever possible, to the target cell 1 to indicate that the mobility procedure is completed for the UE. The target cell 1 may verify the C-RNTI transmitted in the mobility complete message.

Upon successful completion of the conditional mobility to the target cell (i.e., upon successful completion of the random access procedure to the target cell and/or upon transmitting the mobility complete message to the target cell), the UE may stop the T304 timer. On the other hand, when the T304 timer is not stopped and expires, the UE may detect a mobility failure/conditional mobility failure, and initiate a failure recovery procedure.

In step S921, the target cell 1 may transmit a sequence number (SN) status request message to the source cell. The target cell 1 may request the source cell to inform the target cell 1 of a SN of a packet the target cell 1 has to transmit after the mobility, via the SN status request message.

In step S923, the source cell may transmit a conditional mobility cancellation message to the target cell 2 which is not selected as a target cell for a mobility among the candidate target cells. After receiving the conditional mobility cancellation message, the target cell 2 may release resources that are reserved in case of a mobility.

In step S925, the target cell 2 may transmit a conditional mobility cancellation confirmation message to the source cell, as a response for the conditional mobility cancellation message. The conditional mobility cancellation confirmation message may inform that the target cell 2 has released resources reserved in case of a mobility.

In step S927, the source cell may transmit a SN status transfer message to the target cell 1, as a response for the SN status request message. The SN status transfer message may inform the target cell 1 of a SN of a packet the target cell 1 has to transmit after the mobility.

In step S929, the source cell may perform a data forwarding to the target cell 1. For example, the source cell may forward data received from a core network to the target cell 1 so that the target cell 1 can now transmit the data to the UE.

For conditional reconfiguration/conditional mobility, the network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition. The network provides the configuration parameters for the target SpCell in the ConditionalReconfiguration IE.

In NR-DC, the UE may receive two independent conditionalReconfiguration:
a conditionalReconfiguration associated with MCG, that is included in the RRCReconfiguration message received via SRB1; and
a conditionalReconfiguration, associated with SCG, that is included in the RRCReconfiguration message received via SRB3, or, alternatively, included within a RRCReconfiguration message embedded in a RRCReconfiguration message received via SRB1.

In this case:
the UE maintains two independent VarConditionalReconfig, one associated with each conditionalReconfiguration;
the UE independently performs conditional reconfiguration/conditional mobility for each conditionalReconfiguration and the associated VarConditionalReconfig, unless explicitly stated otherwise;
the UE performs measurements for the VarConditionalReconfig associated with the same cell group like the measConfig.

In EN-DC, the VarConditionalReconfig is associated with the SCG.

In NE-DC and when no SCG is configured, the VarConditionalReconfig is associated with the MCG.

The UE performs the following actions based on a received ConditionalReconfiguration IE:
1> if the ConditionalReconfiguration contains the condReconfigToRemoveList:
2> perform conditional reconfiguration removal procedure;
1> if the ConditionalReconfiguration contains the condReconfigToAddModList:
2> perform conditional reconfiguration addition.

For conditional reconfiguration removal, the UE shall:
1> for each condReconfigId value included in the condReconfigToRemoveList that is part of the current UE conditional reconfiguration in VarConditionalReconfig:
2> remove the entry with the matching condReconfigId from the VarConditionalReconfig.

The UE does not consider the message as erroneous if the condReconfigToRemoveList includes any condReconfigId value that is not part of the current UE configuration.

For conditional reconfiguration addition/modification, for each condReconfigId received in the condReconfigToAddModList IE the UE shall:
1> if an entry with the matching condReconfigId exists in the condReconfigToAddModList within the VarConditionalReconfig:
2> if the entry in condReconfigToAddModList includes an condExecutionCond or condExecutionCondSCG;
3> replace condExecutionCond or condExecutionCondSCG within the VarConditionalReconfig with the value received for this condReconfigId;
2> if the entry in condReconfigToAddModList includes an condRRCReconfig;
3> replace condRRCReconfig within the VarConditionalReconfig with the value received for this condReconfigId;
1> else:
2> add a new entry for this condReconfigId within the VarConditionalReconfig;
1> perform conditional reconfiguration evaluation.

For conditional reconfiguration evaluation, the UE shall:
1> for each condReconfigId within the VarConditionalReconfig:
2> if the RRCReconfiguration within condRRCReconfig includes the masterCellGroup including the reconfigurationWithSync:
3> consider the cell which has a physical cell identity matching the value indicated in the ServingCellConfigCommon included in the reconfigurationWithSync within the masterCellGroup in the received condRRCReconfig to be applicable cell;
2> else if the RRCReconfiguration within condRRCReconfig includes the secondaryCellGroup including the reconfigurationWithSync:
3> consider the cell which has a physical cell identity matching the value indicated in the ServingCellConfigCommon included in the reconfigurationWithSync within the secondaryCellGroup within the received condRRCReconfig to be applicable cell;
2> if condExecutionCondSCG is configured:
3> in the remainder of the procedure, consider each measId indicated in the condExecutionCondSCG as a measId in the VarMeasConfig associated with the SCG measConfig;
2> if condExecutionCond is configured:
3> if it is configured via SRB3 or configured within nr-SCG or within nr-SecondaryCellGroupConfig:
4> in the remainder of the procedure, consider each measId indicated in the condExecutionCond as a measId in the VarMeasConfig associated with the SCG measConfig;
3> else:
4> in the remainder of the procedure, consider each measId indicated in the condExecutionCond as a measId in the VarMeasConfig associated with the MCG measConfig;
2> for each measId included in the measIdList within VarMeasConfig indicated in the condExecutionCond or condExecutionCondSCG associated to condReconfigId:
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarCondinionalReconfig:
4> consider the event associated to that measId to be fulfilled;
3> if the measId for this event associated with the condReconfigId has been modified; or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;
3> initiate the conditional reconfiguration execution.

Up to 2 MeasId can be configured for each condReconfigId. The conditional reconfiguration event of the 2 MeasId may have the same or different event conditions, triggering quantity, time to trigger, and triggering threshold.

For conditional reconfiguration evaluation of SN initiated inter-SN CPC for EN-DC, the UE shall:
1> for each condReconfigurationId within the VarConditionalReconfiguration:
2> for each measId included in the measIdList within VarMeasConfig indicated in the CondReconfigExecCondSCG contained in the triggerConditionSN associated to the condReconfigurationId:
3> if the entry condition(s) applicable for the event associated with that measId, is fulfilled for the applicable cells for all measurements after layer 3 filtering taken during the corresponding timeToTrigger defined for this event associated with that measId:
4> consider this event to be fulfilled;
3> if the measId for this event has been modified; or
3> if the leaving condition(s) applicable for this event associated with that measId, is fulfilled for the applicable cells for all measurements after layer 3 filtering taken during the corresponding timeToTrigger defined for this event associated with that measId:
4> consider this event associated to that measId to be not fulfilled;
2> if trigger conditions for all events associated with the measId(s) indicated in the CondReconfigExecCondSCG contained in the triggerConditionSN are fulfilled:
3> consider the target cell candidate within the RRCReconfiguration message contained in nr-SecondaryCellGroupConfig in the RRCConnectionReconfiguration message, contained in the stored condReconfigurationToApply, associated to that condReconfigurationId, as a triggered cell;
3> initiate the conditional reconfiguration execution.
For conditional reconfiguration execution, the UE shall:
1> if more than one triggered cell exists:
2> select one of the triggered cells as the selected cell for conditional reconfiguration execution;
1> else:
2> consider the triggered cell as the selected cell for conditional reconfiguration execution;
1> for the selected cell of conditional reconfiguration execution:
2> apply the stored condRRCReconfig of the selected cell and perform actions as RRCReconfiguration is received by the UE (e.g., random access procedure).

If multiple NR cells are triggered in conditional reconfiguration execution, it is up to UE implementation which one to select, e.g. the UE considers beams and beam quality to select one of the triggered cells for execution.

Hereinafter, selective CG activation and/or optimized mobility for selective CG activation is described.

When the UE moves from the coverage area of one cell to another cell, at some point a serving cell change needs to be performed. Serving cell change may be triggered by L3 measurements and is done by RRC signalling which triggered Reconfiguration with Synchronisation for change of PCell and PSCell, as well as release/add for SCells when applicable. The serving cell change involves complete L2 (and L1) resets, leading to longer latency, larger overhead and longer interruption time than beam switch mobility. The goal of L1/L2 mobility enhancements is to enable a serving cell change via L1/L2 signalling, in order to reduce the latency, overhead and interruption time.

In Conditional PSCell change (CPC)/Conditional PSCell addition (CPA), a CPC/CPA-configured UE has to release the CPC/CPA configurations when completing random access towards the target PSCell. Hence the UE doesn't have a chance to perform subsequent CPC/CPA without prior CPC/CPA reconfiguration and re-initialization from the network. This will increase the delay for the cell change and increase the signaling overhead, especially in the case of frequent SCG changes when operating FR2. Therefore, MR-DC with selective activation of cell groups aims at enabling subsequent CPC/CPA after SCG change, without reconfiguration and re-initialization on the CPC/CPA preparation from the network. This results in a reduction of the signalling overhead and interrupting time for SCG change.

In the present disclosure, optimized mobility may comprise a mobility based on previously stored mobility commands, without reconfiguration and/or re-initialization for the mobility preparation by network. For the optimized mobility, UE may perform the following steps:

Step 1) UE may receive mobility commands for a plurality of candidate target cells, based on reconfiguration and/or re-initialization for the mobility preparation by network.

Step 2) UE may store the mobility commands.

Step 3) When an execution condition for a target cell is fulfilled, UE may perform a mobility to the target cell based on a mobility command for the target cell. Performing the mobility to the target cell may comprise applying a target cell configuration for the target cell and/or performing a random access to the target cell.

Step 4) After completing the mobility to the target cell, UE may maintain the mobility commands stored in step 2. That is, UE may not release the mobility commands stored in step 2 after completing the mobility to the target cell.

Step 5) When UE performs a mobility after step 4, UE may perform the mobility based on the stored mobility command, without reconfiguration and/or re-initialization for the mobility preparation by network. This mobility may correspond to the optimized mobility.

In the optimized mobility procedure, the UE may perform mobility without receiving additional reconfiguration and perform re-initialization using the given conditional mobility commands. This means that the UE may maintain the given conditional mobility commands regardless of the change of the serving cells and use the conditional mobility commands whenever the condition is met.

Since the UE has information on candidate cells related to the optimized mobility for the selective CG activation when SCG failure is detected, a method for a fast connection recovery on SCG may be useful.

However, due to the source PSCell link problem, the execution conditions for conditional PSCell change cannot be used for the connection recovery. If there is a problem with the PSCell link, the evaluation of the current PSCell cannot be performed. This is because the cell quality of a cell with a link problem is not a meaningful measurement result to compare with other cells.

In addition, since the execution condition for conditional PSCell addition may be excluded from evaluation after PSCell addition, the execution condition for conditional PSCell addition cannot be used for the connection recovery without an additional procedure.

In the present disclosure, when the UE has the optimized mobility information including one or more candidate cell information, if the UE detects a connection failure of SCG, the UE may perform an evaluation of execution condition(s) for the connection failure recovery based on the given candidate cells that have additional execution condition(s) for the connection failure recovery indicated in advance by the network.

As for the additional execution conditions for the connection failure recovery, the execution conditions for the conditional PSCell change or the conditional PSCell addition may be reused for the corresponding candidate cell, or new execution condition(s) for conditional PSCell addition may be used with a separate indication.

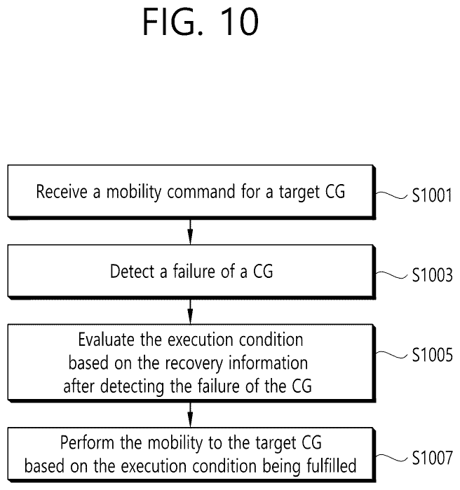

FIG. 10 shows an example of a method performed by a UE according to an embodiment of the present disclosure. The method may also be performed by a wireless device.

Referring to FIG. 10, in step S1001, the UE may receive a mobility command for a target CG. The mobility command may comprise an execution condition for a mobility to the target CG, and recovery information informing that the execution condition is used as a condition for a failure recovery. The mobility to the target CG may comprise a mobility to a SpCell in the target CG.

In step S1003, the UE may detect a failure of a CG. The failure of the CG may comprise at least one of: a radio link failure (RLF) on the CG; a beam failure on the CG; or a failure of a mobility to the CG. The failure of the CG may comprise a failure of an SpCell in the CG.

In step S1005, the UE may evaluate the execution condition based on the recovery information after detecting the failure of the CG. For example, the UE may perform a measurement on the target CG, and determine whether the execution condition for the target CG is fulfilled based on the measurement on the target CG. The UE may delay a transmission of failure information to report the failure of the CG after the failure of the CG, based on the recovery information. On the other hand, based on the recovery information being not included in the mobility command, the UE may transmit the failure information to the network after/upon detecting the failure of the CG, instead of delaying the transmission of the failure information.

In step S1007, the UE may perform the mobility to the target CG based on the execution condition being fulfilled. Based on the mobility to the target CG being succeeded, the UE may transmit, to a network, a mobility complete message informing that the mobility to the target CG has been successfully completed after the failure of the CG, and determine not to transmit the failure information to the network. Based on the mobility to the target CG being failed or the execution condition being not fulfilled, the UE may transmit the failure information to the network, and suspend the CG until receiving a signalling for recovery.

According to various embodiments, the CG may comprise at least one of a MCG or a SCG. An SpCell in the MCG may comprise a PCell, and an SpCell in the SCG may comprise a PSCell.

According to various embodiments, the mobility to the CG may comprise at least one of a handover to a PCell in an MCG, a PSCell change to a PSCell in an SCG, or a PSCell addition of the PSCell in the SCG. The mobility to the target CG may comprise at least one of a handover to a PCell in a target MCG, a PSCell change to a PSCell in a target SCG, or a PSCell addition of the PSCell in the target SCG.

According to various embodiments, the UE may receive, from a network, information for a timer (e.g., T3xx timer). The transmission of the failure information may be delayed while the timer is running. The timer may be started upon the UE detecting the failure of the CG. The timer may be stopped based on the mobility to the target CG being succeeded. Upon an expiry of the timer, the failure information may be transmitted to the network.

According to various embodiments, the mobility command for the target CG may comprise multiple execution conditions for the mobility to the target CG, including the execution condition. The recovery information may inform one or more of the multiple execution conditions used as a condition for a failure recovery, and the remaining execution conditions not informed by the recovery information is not used as a condition for a failure recovery.

According to various embodiments, the UE may receive one or more mobility commands for a target cell group with information for one or more cells and one or more execution conditions. The one or more execution conditions may additionally indicate whether each condition can be used to recover the target cell group when the connection/link failure of the target cell group is detected. The UE may check whether there is/are one or more execution conditions to recover the connection/link failure of the target cell group after detecting connection/link failure of the target cell group. The UE may evaluate one or more execution conditions based on the check to recover the connection/link failure of the target cell group. The UE may perform mobility of the target cell group if at least one execution condition to recover the connection/link failure of the target cell group is met.

Furthermore, the method in perspective of the UE described above in FIG. 10 may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving a mobility command for a target cell group (CG), wherein the mobility command comprises an execution condition for a mobility to the target CG, and recovery information informing that the execution condition is used as a condition for a failure recovery; detecting a failure of a CG; evaluating the execution condition based on the recovery information after detecting the failure of the CG; and performing the mobility to the target CG based on the execution condition being fulfilled.

Furthermore, the method in perspective of the UE described above in FIG. 10 may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving a mobility command for a target cell group (CG), wherein the mobility command comprises an execution condition for a mobility to the target CG, and recovery information informing that the execution condition is used as a condition for a failure recovery; detecting a failure of a CG; evaluating the execution condition based on the recovery information after detecting the failure of the CG; and performing the mobility to the target CG based on the execution condition being fulfilled.

Furthermore, the method in perspective of the UE described above in FIG. 10 may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving a mobility command for a target cell group (CG), wherein the mobility command comprises an execution condition for a mobility to the target CG, and recovery information informing that the execution condition is used as a condition for a failure recovery; detecting a failure of a CG; evaluating the execution condition based on the recovery information after detecting the failure of the CG; and performing the mobility to the target CG based on the execution condition being fulfilled.

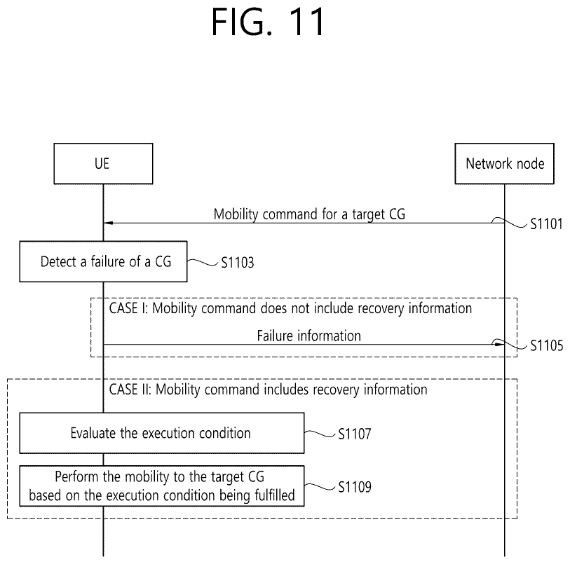

FIG. 11 shows an example of a signal flow between a UE and a network node according to an embodiment of the present disclosure. The network node may comprise a base station (BS).

Referring to FIG. 11, in step S1101, the network node may transmit, to a UE, a mobility command for a target CG. The mobility command may comprise an execution condition for a mobility to the target CG.

In step S1103, the UE may detect a failure of a CG.

In some implementations, the mobility command may not include recovery information informing that the execution condition is used as a condition for a failure recovery. In this case, in step S1105, the network node may receive, from the UE, failure information to report the failure of the CG detected by the UE.

In some implementations, the mobility command may include the recovery information. In this case, in step S1107, the UE may evaluate the execution condition after detecting the failure of the CG. In step S1109, the UE may perform the mobility to the target CG based on the execution condition being fulfilled.

Furthermore, the method in perspective of the network node described above in FIG. 11 may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: transmitting, to a user equipment (UE), a mobility command for a target cell group (CG), wherein the mobility command comprises an execution condition for a mobility to the target CG; and receiving, from the UE, failure information to report a failure of a CG detected by the UE, based on recovery information being not included in the mobility command. The recovery information informs that the execution condition is used as a condition for a failure recovery. Based on the recovery information being included in the mobility command, the UE is configured to: evaluate the execution condition after detecting the failure of the CG; and perform the mobility to the target CG based on the execution condition being fulfilled.

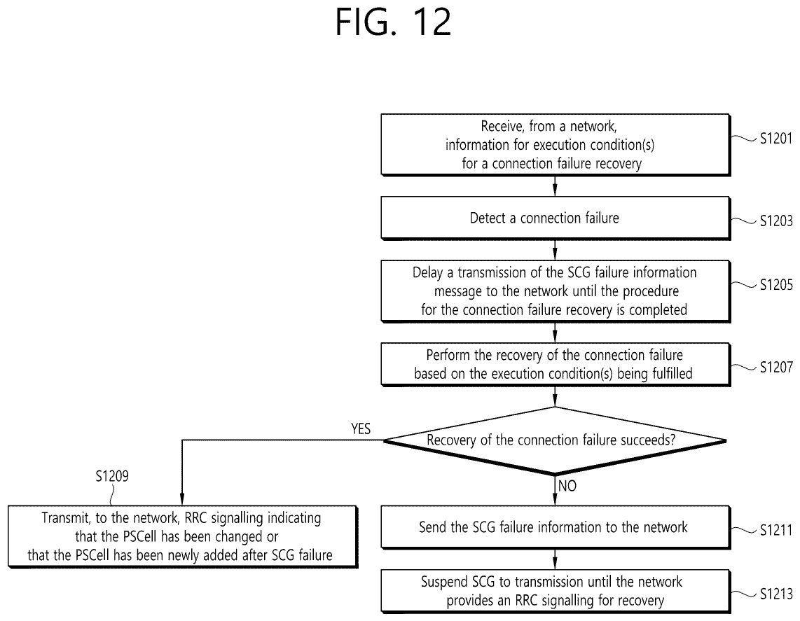

FIG. 12 shows an example of a method for a failure recovery according to an embodiment of the present disclosure. The method may be performed by a UE and/or a wireless device.

Referring to FIG. 12, in step S1201, the UE may receive, from a network, information for execution condition(s) for a connection failure recovery. The execution conditions(s) may be a condition for executing a mobility to a target cell (e.g., mobility condition). The target cell may be a candidate cell for a conditional mobility. The UE may receive a mobility command for the target cell comprising the information for the execution condition(s).

In step S1203, the UE may detect a connection failure. For example, the UE may detect a failure of SCG.

In step S1205, if the execution condition(s) for the connection failure recovery is provided to the UE, the UE may not transmit the SCG failure information message to the network until the procedure for the connection failure recovery is completed.

In step S1207, the UE may perform the recovery of the connection failure based on the execution condition(s) being fulfilled. For example, the UE may attempt to access to one of the candidate cells.

In step S1209, if the UE succeeds in the recovery of the connection failure, i.e., the UE access to one of the candidate cells successfully, the UE may transmit, to the network, RRC signalling (e.g. RRC Reconfiguration Complete) indicating that the PSCell has been changed or that the PSCell has been newly added after SCG failure, instead of sending the SCG failure information.

In step S1211, if the UE has failed the connection failure recovery and has not yet sent the SCG failure information to the network, the UE may send the SCG failure information to the network.

In step S1213, the UE may suspend SCG to transmission until the network provides an RRC signalling for recovery.

For instance, the network may provide the UE with multiple execution conditions for one candidate cell. The UE may perform evaluation for the connection failure recovery by using the certain execution condition(s) only specifically indicated by the network for the case of SCG failure among all multiple execution conditions. If there is no execution condition for the connection failure recovery or the network does not allow the connection failure recovery to the UE, the UE may transmit the SCG failure information and suspend RRC transmission until recovery form the network. Alternatively, if there are one or more pre-defined execution conditions, e.g., event A4 condition or event B1 condition, between the network and the UE, the UE can evaluate one or more execution conditions without indication from the network for the connection failure recovery. If the pre-defined execution conditions can be the execution conditions for PSCell addition, the UE may maintain the execution conditions for this PSCell addition after PSCell addition is completed, but does not evaluate the pre-defined execution conditions until SCG failure is detected.

If the network allows the connection failure recovery and does not provide a pre-defined execution condition, the UE may perform a cell selection based on cell selection criteria to select a suitable cell among all candidate cells, like the CHO failure recovery procedure.

If the UE performs the connection failure recovery without transmitting SCG failure information, the network may provide an additional timer (e.g., T3xx timer) to know when the UE is not allowed to perform evaluation for the connection failure recovery. That is, when the additional timer expires, the UE may regard the connection failure recovery as a failure and transmit the SCG failure information to the network.

For example, when a UE detects an SCG failure, the UE may selectively perform an SCG failure information procedure based on the execution condition(s).

The purpose of the SCG failure information procedure is to inform E-UTRAN or NR MN about an SCG failure the UE has experienced i.e. SCG radio link failure, failure of SCG reconfiguration with sync, SCG configuration failure for RRC message on SRB3, SCG integrity check failure, and consistent uplink LBT failures on PSCell for operation with shared spectrum channel access.

A UE may initiate the procedure to report SCG failures when neither MCG nor SCG transmission is suspended and when one of the following conditions is met:
1> upon detecting radio link failure for the SCG;
1> upon detecting beam failure of the PSCell while the SCG is deactivated;
1> upon reconfiguration with sync failure of the SCG;
1> upon SCG configuration failure;
1> upon integrity check failure indication from SCG lower layers concerning SRB3.

Upon initiating the procedure, the UE shall:
1> if the procedure was not initiated due to beam failure of the PSCell while the SCG is deactivated:
2> suspend SCG transmission for all SRBs, DRBs and, if any, BH RLC channels;
2> reset SCG MAC;
1> stop T304 for the SCG, if running;
1> stop conditional reconfiguration evaluation for CPC, if configured;
1> if the UE is allowed to perform the connection failure recovery or is configured an information to performs the connection failure recovery; and
1> if the condExecutionCond or the condExecutionCondSCG are configured to perform the connection failure recovery:
2> start timer T3xx;
2> perform conditional reconfiguration evaluation based on the condExecutionCond or the condExecutionCondSCG only for the connection failure recovery;
1> else:
2> if the UE is in (NG)EN-DC:
3> initiate transmission of the SCGFailureInformationNR message.
2> else:
3> initiate transmission of the SCGFailureInformation message.

The present disclosure may have various advantageous effects.

For example, in a situation in which the UE has a list of candidate cell information (e.g., execution condition(s) for candidate cell) for conditional mobility, the UE can quickly perform a connection recovery based on candidate cell information in the list for optimized mobility allowed by the network.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) configured to operate in a wireless communication system, the method comprising:
receiving a mobility command for a target cell group (CG), wherein the mobility command comprises an execution condition for a mobility to the target CG, and recovery information informing that the execution condition is used as a condition for a failure recovery;
detecting a failure of a CG;
evaluating the execution condition based on the recovery information after detecting the failure of the CG; and
performing the mobility to the target CG based on the execution condition being fulfilled.

2. The method of claim 1, wherein the failure of the CG comprises at least one of:
a radio link failure (RLF) on the CG;
a beam failure on the CG; or
a failure of a mobility to the CG.

3. The method of claim 1, wherein the failure of the CG comprises a failure of a special cell (SpCell) in the CG,
wherein the mobility to the target CG comprises a mobility to a SpCell in the target CG,
wherein the CG comprises at least one of a master cell group (MCG) or a secondary cell group (SCG), and
wherein an SpCell in the MCG comprises a primary cell (PCell), and an SpCell in the SCG comprises a primary secondary cell (PSCell).

4. The method of claim 3, wherein the mobility to the CG comprises at least one of a handover to a PCell in an MCG, a PSCell change to a PSCell in an SCG, or a PSCell addition of the PSCell in the SCG, and
wherein the mobility to the target CG comprises at least one of a handover to a PCell in a target MCG, a PSCell change to a PSCell in a target SCG, or a PSCell addition of the PSCell in the target SCG.

5. The method of claim 1, wherein the evaluating of the execution condition comprises:
performing a measurement on the target CG; and
determining whether the execution condition for the target CG is fulfilled based on the measurement on the target CG.

6. The method of claim 1, further comprising delaying a transmission of failure information to report the failure of the CG after the failure of the CG, based on the recovery information.

7. The method of claim 6, based on the mobility to the target CG being succeeded, further comprising:
transmitting, to a network, a mobility complete message informing that the mobility to the target CG has been successfully completed after the failure of the CG; and
determining not to transmit the failure information to the network.

8. The method of claim 6, based on the mobility to the target CG being failed or the execution condition being not fulfilled, further comprising:
transmitting the failure information to the network;
suspending the CG until receiving a signalling for recovery.

9. The method of claim 6, further comprising receiving, from a network, information for a timer,
wherein the transmission of the failure information is delayed while the timer is running, and
wherein the timer is started upon the UE detecting the failure of the CG.

10. The method of claim 9, wherein the timer is stopped based on the mobility to the target CG being succeeded.

11. The method of claim 9, wherein the failure information is transmitted to the network upon an expiry of the timer.

12. The method of claim 1, wherein the mobility command for the target CG comprises multiple execution conditions for the mobility to the target CG, including the execution condition, and
wherein the recovery information informs one or more of the multiple execution conditions used as a condition for a failure recovery, and the remaining execution conditions not informed by the recovery information is not used as a condition for a failure recovery.

13. The method of claim 1, wherein the UE is in communication with at least one of a mobile device, a network, or autonomous vehicles.

14. A user equipment (UE) configured to operate in a wireless communication system, the UE comprising:
at least one transceiver;
at least one processor; and
at least one memory operatively coupled to the at least one processor and storing instructions that, based on being executed by the at least one processor, perform operations comprising:
receiving a mobility command for a target cell group (CG), wherein the mobility command comprises an execution condition for a mobility to the target CG, and recovery information informing that the execution condition is used as a condition for a failure recovery;
detecting a failure of a CG;
evaluating the execution condition based on the recovery information after detecting the failure of the CG; and
performing the mobility to the target CG based on the execution condition being fulfilled.

15. (canceled)

16. A network node configured to operate in a wireless communication system, the network node comprising:
at least one transceiver;
at least one processor; and
at least one memory operatively coupled to the at least one processor and storing instructions that, based on being executed by the at least one processor, perform operations comprising:
transmitting, to a user equipment (UE), a mobility command for a target cell group (CG), wherein the mobility command comprises an execution condition for a mobility to the target CG; and
receiving, from the UE, failure information to report a failure of a CG detected by the UE, based on recovery information being not included in the mobility command,
wherein the recovery information informs that the execution condition is used as a condition for a failure recovery, and
wherein, based on the recovery information being included in the mobility command, the UE is configured to:
evaluate the execution condition after detecting the failure of the CG; and
perform the mobility to the target CG based on the execution condition being fulfilled.

17-20. (canceled)
